(19) United States
(12) Patent Application Publication
(10) Pub. No.: US 2011/0098018 A1
(43) Pub. Date: Apr. 28, 2011

(54) SYSTEMS AND METHODS TO MANAGE AND CONTROL WIRELESS SERVICE USAGE

(76) Inventor: Mark Engel, Tampa, FL (US)

(21) Appl. No.: 12/606,557

(22) Filed: Oct. 27, 2009

(51) Int. Cl. H04W 4/26; H04W 4/12

(52) U.S. Cl. 455/406; 455/466

(57) ABSTRACT

A method and system for monitoring wireless service utilization is described. The teachings comprise: providing a logical database comprising service usage records providing triggers for a wireless service consumed by a wireless device; providing a contact address associated with the wireless device; after an interval, determining if the utilization consumed to-date for a current billing period by the wireless device activates one of the triggers, wherein the interval is at least an order of magnitude less than a billing period; generating a message corresponding to the activated trigger, with the message including values determined during the determining step; and sending the message to the contact address.

### FIELD

Solutions to manage a wireless user's pattern of use and control on expenses are described. These solutions encompass a variety of methods and systems in relation to the offered communication services. Control information can be generated on a periodic basis. The control information can be used to communicate and facilitate policies and procedures.

### SUMMARY

According to various embodiments, a method for monitoring wireless service utilization is described. The method comprises: providing a logical database comprising service usage records providing triggers for a wireless service consumed by a wireless device; providing a contact address associated with the wireless device; after an interval, determining if the utilization consumed to-date for a current billing period by the wireless device activates one of the triggers, wherein the interval is at least an order of magnitude less than a billing period; generating a message corresponding to the activated trigger, with the message including values determined during the determining step; and sending the message to the contact address.

In some embodiments, the method further comprises summarizing the usage records for the interval prior to the determining and storing the summarized usage records.

In some embodiments, the determining comprises adding the usage records created within the interval to a summary usage record summarizing a period between the start of the billing period and the interval start.

In some embodiments, the logical database groups usage records by an account number with the account number grouping subscribers.

In some embodiments, the logical database comprises one or more databases that are commonly keyed and owned by different entities.

In some embodiments, the interval is 24 hours.

In some embodiments, the contact address comprises one or more of a telephone number, an email address, or an instant message user identifier.

In some embodiments, the contact address contacts one of more of a subscriber, a subscriber supervisor, a service provider account manager, or a wireless carrier billing manager.

In some embodiments, the logical database comprises importing a file including usage records from a wireless carrier database.

In some embodiments, the importing comprises receiving an email including the file at a desired email address, and inserting the usage records included in the file into the logical database.

In some embodiments, the importing comprises sending a notification email to a service provider.

In some embodiments, the wireless service comprises controlling one or more of voice minutes, text messages, multi-media messages or bytes of data.

In some embodiments, the wireless service comprises controlling expenses incurred for international calls.

In some embodiments, the method further comprises disabling a use of a service that activated the trigger until the end of the billing period.

In some embodiments, the trigger comprises one or more of usage control, number watch control, time of day control, text messaging control, 411 control, and 911 control.

In some embodiments, a system for monitoring wireless service utilization is described. The system comprises a logical database comprising service usage records; triggers for a wireless service consumed by a wireless device; a contact address associated with the wireless device; a trigger processing module that run after an interval to determine if the utilization consumed to-date for a current billing period by the wireless device activates one of the triggers, wherein the interval is at least an order of magnitude less than a billing period; a message generator to generate a message corresponding to the activated trigger, with the message including values determined by the trigger processing module; and a message sender to send the message to the contact address.

In some embodiments, the system further comprises a summarizer to collate the usage records for the interval and a storage to store the summarized usage records.

In some embodiments, the determining comprises adding the usage records created within the interval to a summary usage record summarizing a period between the start of the billing period and the interval start.

In some embodiments, the logical database groups usage records by an account number with the account number grouping subscribers.

In some embodiments, the logical database comprises one or more databases that are commonly keyed and owned by different entities.

In some embodiments, the contact address comprises one or more of a telephone number, an email address, or an instant message user identifier.

In some embodiments, the system further comprises a data collection module to import a file including usage records from a wireless carrier.

In some embodiments, the data collection module comprises an email agent to receive the file at a desired email address and a data import to import the usage records included in the file.

In some embodiments, the system further comprises a notification email agent to transmit a message to a service provider.

In some embodiments, the trigger processing module comprises controls for one or more of multi-media messages or bytes of data.

In some embodiments, the trigger processing module comprises controls for expenses incurred for international calls.

In some embodiments, the system further comprises a service ticket module to disable a use of a service that activated the trigger till the end of the billing period.

In some embodiments, the trigger processing module comprises controls for one or more of usage control, number watch control, time of day control, text messaging control, 411 control, and 911 control.

In some embodiments, a computer readable medium in which software is recorded, wherein the software is configured to implement a method for monitoring wireless service utilization is described. The method comprises providing a logical database comprising service usage records; providing triggers for a wireless service consumed by a wireless device; providing a contact address associated with the wireless device; after an interval, determining if the utilization consumed to-date for a current billing period by the wireless device activates one of the triggers, wherein the interval is at least an order of magnitude less than a billing period; generating a message corresponding to the activated trigger, with the message including values determined during the determining step; and sending the message to the contact address.

### BRIEF DESCRIPTION OF THE DRAWINGS

The same reference number represents the same element on all drawings. It should be noted that the drawings are not necessarily to scale. The foregoing and other objects, aspects, and advantages are better understood from the following detailed description of a preferred embodiment of the invention with reference to the drawings, in which:

FIG. 1 illustrates one embodiment of a system to monitor wireless usages;

FIG. 2 illustrates one embodiment of data report;

FIG. 3 illustrates one embodiment of a notification message to a service provider upon receiving a data report to process;

FIG. 4 illustrates one embodiment of a notification message from the data collection module to a service provider when a data report is processed without error;

FIG. 5 illustrates one embodiment of a notification message from the data collection module to a service provider when a data report is processed with an error; and

FIG. 6 illustrates some exemplary values for threshold and trigger setup.

### DETAILED DESCRIPTION

Companies need a more robust way in which to communicate, evaluate, and act on a set of measured results that are collected by all company wireless devices. The evaluation and action needs to be taken close to real-time, so that optimum controls can be exerted. Companies need a simple way to access their wireless usage data on a daily period (24-hours) while also providing a simple and friendly approach to help them communicate to their users about how to better utilize these wireless services.

Presently, companies have to wait until they receive their monthly bill from their wireless services providers by either a paper bill or through an electronic bill before trying to break down usage patterns. In the case of companies, these statements can be thousands of pages long or thousands of lines of data in an electronic spreadsheet type of format. This way of communicating usage information to the client makes it nearly impossible to do an evaluation. Wireless service providers can assign support staff to help their clients or they provide electronic means to make adjustments to the current services. All these methods fall short in providing an easy to use solution that allows companies to see usage patterns as they are occurring. In most cases, they provide very limited or no communication alerts to the companies and their management teams about users usage patterns that are happening live.

According to the present teachings, clients can set limits and thresholds of use in a variety of ways on a variety of wireless services. This allows the client to control usage cost and communicate the results of usage. The users of the present teachings can include subscribers, managers and administrative members of their company. As such, the subscribers of these wireless devices can utilize the subscribed wireless services while having a greater control of how they use these services. The present teachings provide daily updates. In some embodiments, the present teachings formulate the information to control multiple applications of services.

The present teachings provide daily communications regarding usage to end users, managers, and administrators when preset thresholds of usage are met. The system supports a variety of communications including cellular, dispatch, text messaging, 411 calls, 911 calls and more. This system can provide communications to employees about how they are using the wireless network. In some embodiments, the system can provide them solutions to reduce their monthly spend because of this new set communications and control triggers. The present teachings are implemented by the eTriggers™ Usage Controls available from National Orders, Inc. at www.nationalorders.com, which provides an easy-to-use solution for Sprint Nextel customers to control expenses, and manage employees phone usage to policy. eTriggers™ Usage Controls provides telecommunications management teams with peace of mind knowing that their wireless devices are being used responsibly. This allows customers to have better communications with their wireless users about how they are using their devices.

This system is designed to let users know about their usage while it is happening so they stay within their allotted threshold. It helps managers and administrators to know when multiple users are using the system more than they had planned. By communicating with people about usage while it is happening, users fall in line with management's set goals giving an overall higher spend value and reducing unneeded extra pooled minutes. In some embodiments, communication triggers can be set in three key areas: per device/user, management teams, and administrator. In some embodiments, cellular phone use can be restricted for the remainder of the billing cycle if preset allotted time is reached, then automatically opened back up for cell usage for the next billing period.

In some embodiments, a number watch control allows setting of a trigger for a plurality of phone numbers. Once setup, the system can monitor the number of calls per day or percent to-total-calls to manage when the user is calling personal numbers too often.

In some embodiments, a time of day/night control can be used to designate specific times when you do not want users using the phones to avoid added cost. Additionally, this feature can notify managers and administrators when phones are being used outside of business hours.

In some embodiments, a text messaging control can notify a user, manager or administrator when a user starts to hit allotted texting packages. Suspension of texting is an option.

In some embodiments, a 411 control can reduce costs associated with directory assistance. Monthly reporting can be provided to show user's phone number, number of 411 calls and cost.

In some embodiments, 911 control can allow a manager and others to get an email when user calls 911. This allows a company to learn some details of possible legal or human resource liabilities immediately.

According to various embodiments, fraud control can be provided. The system verifies the units that are on a companies account every day. If a new number that is not a registered number on a company's account at the beginning of a billing cycle starts using airtime an administrator can be notified that an unauthorized user is clocking airtime. This may be a new authored unit that was just recently activated, but if it is fraudulent, the administrator can automatically be notified with 48 hours of the wireless unit clocking airtime.

In some embodiments, various reports are available. Reports can be provided daily, weekly, monthly or yearly.

The teachings further allow monitoring of the total pooled minutes used during the current billing cycle for a billing account. The teachings eliminate cellular usage that comes as part of your plan, free incoming, nights and weekends, mobile to mobile, or mobile to any mobile, etc. This allows a company to have a greater accuracy at determining pooled minutes used and needed.

The system receives data records, e.g., call data records from a carrier. The data records can be included in a data table, such as Comma Separated Values (CSV) file. For example, the data table can be retrieved from a network site such as a web-site. In some embodiments, the data file can be received via email. After processing a data file through user-configurable rules, the system can send alerts. The alerts can be defined by user-configurable rules. In some embodiments, the rules can be per phone, per billing account number, per subscriber. In some embodiments, the rules can be configured by a grouping, such as an account number.

According to various embodiments, a customer can be set up as a “Company.” Within any one company there can be one or more accounts. Each account is uniquely identified using a billing account number (BAN). The BAN is unique and can be referred to as an account number and account ID also. Data from a telephone carrier can be received in a data file. In some embodiments, data for each account can be stored in a separate data file. The data file can be generated and processed with a desired frequency. In some embodiments, the frequency can be once a day, once a week or any other desired frequency.

Each account can include one or more subscribers. In some embodiments, a subscriber, can be uniquely identified or keyed by a Personal Telephone Number (PTN). In some embodiments, each subscriber can be a member of only one account. Each account can be created and managed by a service provider. In some embodiments, a company or BAN-approved user can mange an account.

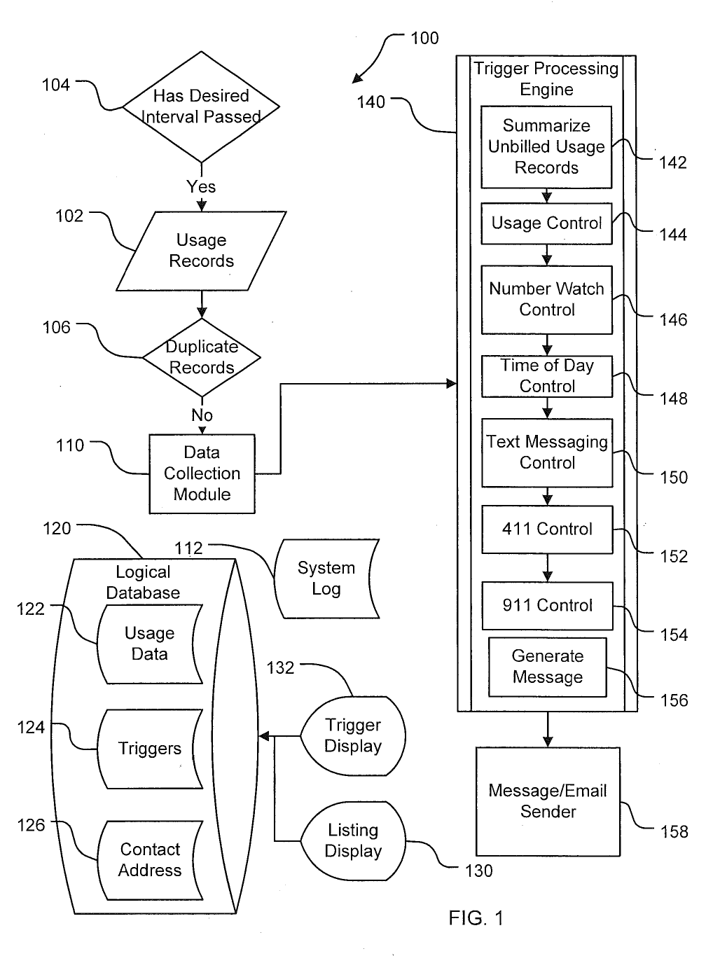

FIG. 1 illustrates one embodiment of a system 100 to monitor wireless usages. When a specified or desired interval of time has passed at step 104 since a previous processing of triggers for the subscribers in an account, usage records 102 can be received from a wireless carrier for a billing account, in some embodiments. Optionally, a check at step 106 can be made to determine if the usage data in usage records 102 has been previously processed. When usage records 102 are new, a data collection module 110 extracts the data from usage records 102 and inserts them into logical database 120. After data collection module 110 has been completed, trigger processing module 140 is invoked. Trigger processing engine 140 can optionally summarize the unbilled usage records at step 142 since the last run of the trigger processing module 140. Trigger processing module 140 can then determine whether a threshold or trigger when the accumulated records are processed by a usage control 144, a number watch control 146, a time of day control 148, a text messaging control 150, a 411 control 152, a 911 control 154 or other similar controls. If a control is triggered, a corresponding message is generated at step 156. A message or email sender 158 than transmits the message.

In some embodiments, logical database 120 can comprise a usage data repository 122, a triggers repository 124, and a contact address repository 126. Data into these repositories can be managed via trigger display 132 and listing display 130. Reports for a service provider, subscriber, and account manager can be provided by report display 134. In some embodiments, displays can be implemented as web-pages. Messages from the processes, modules or displays within system 100 can be logged into system log 112.

In some embodiments, after the unbilled usage data has been processed it can be removed from usage data repository 122. In some embodiments, a beginning of a new billing period resets the calculations for a trigger or a threshold. Embodiments of each of the modules of FIG. 1 are described in more detail below.

### Data Report

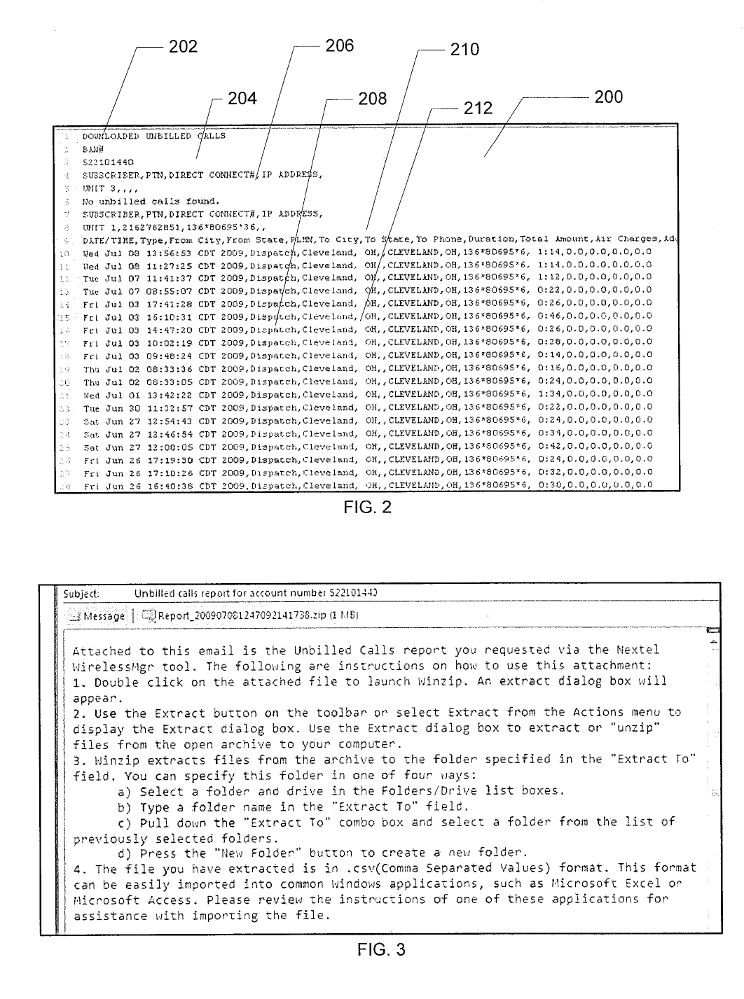

Each day, data reports for individual accounts within each client company are generated and received. According to various embodiments, data report 200 can have a format similar to FIG. 2. Different sections of the report can comprise different number of columns. Report 200 can provide section 202 for unbilled calls. Report 200 can provide a BAN number 204. After the BAN number 204, data report 200 can provide one or more subscriber sections 206 and 208. Some subscribers listed in report 200 may not have any unbilled calls, for example, section 206. This can be indicated by a notation, for example, “No unbilled calls found.” When unbilled calls for a subscriber are included, section 208 can begin with a column header 210. Usage data 212 can follow column header 210. Usage data 212 within section 208 can continue, until another keyword tag, for example, “subscriber” is found.

### Data Collection Module

A data collection module, e.g., data collection module 110 of FIG. 1, can be responsible for processing data reports. The data can be extracted and placed into a set of new database tables. The data collection module can include an email reader. The data collection module can check for availability of a new data report periodically, for example, every 15-30 minutes. In some embodiments, an email reader can be used to process new messages received in a specific mailbox. According to various embodiments, a system can be provisioned with an email address. All emails received by this email address can be processed by the system. FIG. 3 is an example of the type of email that can be processed by the data collection module.

In some embodiments, the data collection module or the email reader can be written in .NET. Implementing these as a service, rather than a stand-alone executable is preferred. This allows for configuration of the data collection module by using a configuration file rather than a scheduler. The communications to a subscriber can be implemented using Token replacement logic for filling in various fields in a subject line and body of a message, for example, an email message. As a windows service, events can be logged to the Windows Event log, this includes errors, start and stop, and other informational messages. In some embodiments, a configuration file can be used to set and update various run-time parameters, including one or more of:
Confirmation Email-Send To:—One or more email addresses, semi-colon delimited list
Confirmation Email-Send From:—Email address to use as the FROM address
Confirmation Email-Subject:—Simple text to use as the subject, which allows the following tokens: BAN, Company Name
Confirmation Email-Body:—Simple text to use as the body of the confirmation email; may also use other tokens, e.g., BAN, Company Name, PTN
TimeInterval:—INTEGER NUMBER representing MINUTES
ProductionMode (Y or N):—Used as a switch between production and QA modes.

In some embodiments, if an error occurs during the processing of a data report, the message can include notification of such error, for example, by appending text such as “(errors occurred)” to a subject line in an email, for example, as seen in FIG. 5. In some embodiments, the PTN can be included in the notification message, allowing a service provider to correct errors as needed.

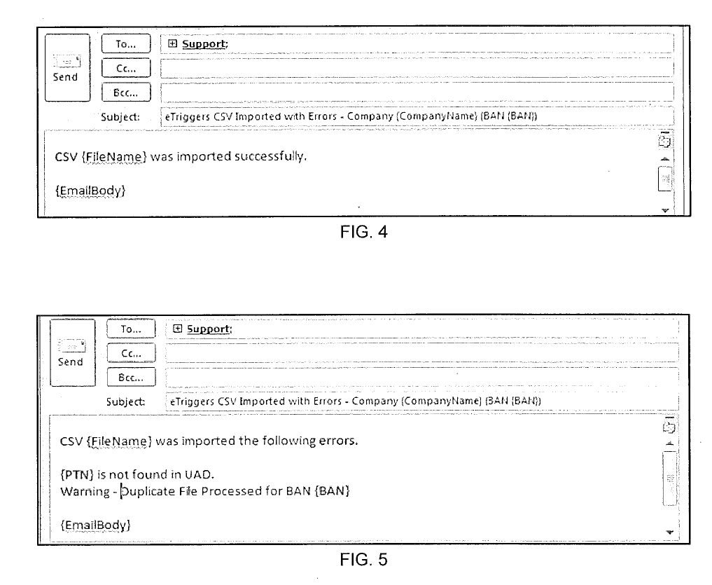

In some embodiments, once the data collection module has processed a data report successfully, a communication, e.g., email, text message, page, or instant message, can be sent to a service agent, for example, as seen in FIG. 4. The communication to the service agent can, for example, include one or more of the following:
BAN
Number of subscribers found
Number of subscribers with unbilled data
Company name that the account belongs to
Import batch number
Current date and time
Length of time to process data report
Non-fatal errors and processing warnings
A copy of the original data report

Any email message that does not have an attachment can be ignored, and the event can be logged. The log can include a from address, subject of the message and the body of the message. In some embodiments, a BAN can be determined from a subject of the email. In FIG. 3, the BAN is 522101440. An email attachment can be copied to a temp location on the server. In some embodiments, the attachment can be compressed in an archive, which has to be unarchived. In some embodiments, the archive includes a file with a name similar to “Unbilled_Report_Ban_{—}522101440Date07-08-2009_{—}1247091212073.csv.” The filename can be used to determine a BAN and the date of the report. According to various embodiments, a data report looks like FIG. 2 in a text editor. The report can have a structured format that is logically organized to assist in parsing.

### Trigger Management Module

The unbilled call information can be processed with triggers and thresholds. In some embodiments, triggers can be setup for accounts. In some embodiments, triggers can be setup and configured for individual subscribers. An account can include one or more subscribers, for example, dozens or hundreds. Each subscriber can have different trigger settings and thresholds. In some embodiments, the triggers and thresholds can be stored in tables.

In some embodiments, a Trigger Management Module including a display can be provided to an account manager, a carrier, or a user to maintain these settings. Access to the trigger display can be secured with a security module. The trigger display can include a capability to filter, sorting, search, insert, update, update multiple items, replace a phrase in multiple items, etc. This facilitates setting a number of values for various triggers and thresholds for one or more subscribers at the same time. The trigger display can include an edit or details view (READ ONLY) display to view trigger elements in more detail and set many options at one time for each account. The security module can control access, for example, by limited access to a service provider, a carrier, etc. The listing, fast edit, and standard edit screens for the triggers display can provide the input mechanism to manage trigger properties and thresholds at the subscriber level for each of their accounts. Once the properties and thresholds have been set, the trigger processing module can start sending usage notifications during its next run cycle when a data report for unbilled calls for an account becomes available.

### Trigger Processing Module

The trigger processing module, e.g., trigger processing module 140 of FIG. 1, scans for trigger threshold exceptions and sending notifications to subscribers and managers as configured for individual subscribers. In some embodiments, the trigger processing module can start each day at 12 A.M. (MDT) and run for as long as needed to complete the processing of any new data. In some embodiments, the processing module can be configured to process data for accounts for which updated reports have been received. For example, if the Company A's data report was uploaded 2 days ago and has not been refreshed since, the processing module can elect not to the old data.

The notifications can be sent to a subscriber's mobile device as a text message. This can be done with a standard email address. In some embodiments, the notification address or type can be provided in the data report. In other embodiments, the notification address or type can be provided in the trigger defining. In some embodiments, multiple recipients and/or multiple types of notifications can be triggered to communicate an alert. For example, the email address can be formed by concatenating a subscriber's PTN to the string “@carrier.com.” The processing engine or module can send TEXT emails, so that if the email address is going to a mobile device, it is readable.

### Database

A database, e.g. logical database 120 of FIG. 1, can be used to manage and store data needed for the teachings herein, usage data, contact information and triggers. In some embodiments, usage data repository 122, a triggers repository 124, and a contact address repository 126 can be part of the database. A table structure to store the fields in the data report can be implemented. Authentication and connection strings for accessing the database can be read from a configuration file. In some embodiments, additional data fields, such as, Import Date and Import Id fields can be added to the table structure. The unbilled subscriber data can be placed in a separate table and any Unbilled Calls by these subscribers can be linked using a key, such as, a Unbilled Subscriber Id field. Data for unmatched subscribers can be recorded and processed, but the event can be noted in a notification message that is sent after each data report is processed. In some embodiments, the unsubscribed PTN can be included in the notification message to allow a service provider to make the necessary corrections.

After all subscribers have been processed, and the unbilled calls logged, a batch query can be used to verify that all subscribers have been recorded and that they trigger a record. The trigger record can be keyed to Unit Account Details (UAD) subscribers or unbilled subscribers based on PTN and Date Bill Cycle. In some embodiments, if a trigger record for a processed subscriber does not exist, a “blank” record can be created for the subscriber. The created record can be updated with a trigger listing display, as necessary.

The start and stop times can be included in the confirmation email. In some embodiments, start and stop times for the processing of each data report can be logged in an Event Viewer. Errors can be included in the body of the confirmation email as well as logged in an operating system log. If the data collection module fails to process the entire data report or insert all data into the database, the occurrence of the error can be flagged as a critical error in the log and confirmation email.

In some embodiments, if a data report is received for a BAN for a period of which data has already been collected, the data collection module can clear the existing data for the period and recollect the data from the most recent data report. In some embodiments, this occurrence can be noted in the confirmation message or system log. For example, text “DUPLICATE FILE PROCESSED FOR BAN {Ban#} Import ID {ImportId} was deleted automatically.”

According to various embodiments, a trigger confirmation email on success is shown in FIG. 4. According to various embodiments, a trigger confirmation email with errors in shown in FIG. 5.

### Trigger Listing Display/Screen

The listing screen, e.g., listing display 130 and trigger display 132 of FIG. 1, can be used by a service provider to locate subscribers to setup their triggers. The trigger fields define various properties for a subscriber, for example, thresholds for the triggers. In some embodiments, the listing screen can provide fields that allow a service provider to lookup and search triggers for a subscriber. Examples of such fields can include one or more of: BAN, Departmental Account Code (DAC) Name, DAC number, Unit Name, Unit Type, Plan Description, and Date Bill Cycle. In some embodiments, a subscriber can have one or more records in the UAD Subscribers table for previous month's billing. Where more than one UAD record exists for a particular PTN, the most current PTN record based on the most recent Date Bill Cycle is used. Nearly all trigger fields and UAD fields can be displayed and searched in the listing screen including, email addresses, locked fields from UAD, editable fields from triggers properties. BAN, plan description, DAC name, cell allotted time, group number, group code, etc. Some of the fields can be locked, i.e., no updates to the field are allowed. In some embodiments, the unbilled call information can be removed from the listing screen. A rough assessment of the fields needed for this listing screen is as follows. The naming convention here is lust for reference.

| | | | |
|---|---|---|---|
| UsageTrigger-Cell-Threshold | Numeric | UsageTrigger-Cell-50 | Y/N |
| UsageTrigger-Cell-75 | Y/N | UsageTrigger-Cell-100 | Y/N |
| UsageTrigger-Cell-150 | Y/N | UsageTrigger-Cell-UserEmail | Text |
| UsageTrigger-Cell-MgrEmail | Text | UsageTrigger-Cell-AdminEmail | Text |
| UsageTrigger-Cell- | Y/N | UsageTrigger-Cell-IsActive | Y/N |
| RestrictUsage | | | |
| UsageTrigger-Disp-Threshold | Numeric | UsageTrigger-Disp-50 | Y/N |
| UsageTrigger-Disp-75 | Y/N | UsageTrigger-Disp-100 | Y/N |
| UsageTrigger-Disp-150 | Y/N | UsageTrigger-Disp-UserEmail | Text |
| UsageTrigger-Disp-MgrEmail | Text | UsageTrigger-Disp-AdminEmail | Text |
| UsageTrigger-Disp- | Y/N | UsageTrigger-Disp-IsActive | Bool |
| RestrictUsage | | | |
| NbrWatch-IsActive | Y/N | NbrWatch-Calc-Formula | Text |
| NbrWatch-SpouseNbr | Text | NbrWatch-HomeNbr | Text |
| NbrWatch-OtherNbr1 | Text | NbrWatch-OtherNbr2 | Text |
| NbrWatch-OtherNbr3 | Text | NbrWatch-UserEmail | Text |
| NbrWatch-MgrEmail | Text | NbrWatch-AdminEmail | Text |
| TimeOfDay-IsActive | Y/N | TimeOfDay-UserEmail | Text |
| TimeOfDay-MgrEmail | Text | TimeOfDay-AdminEmail | Text |
| TimeOfDay-UsageTypes | Text | TimeOfDay-Start1 | Text |
| TimeOfDay-End1 | Text | TimeOfDay-Star2 | Text |
| TimeOfDay-End2 | Text | | |
| TextMsg-IsActive | Y/N | TextMsg-Threshold | Numeric |
| TextMsg-50 | Y/N | TextMsg-75 | Y/N |
| TextMsg-100 | Y/N | TextMsg-150 | Y/N |
| TextMsg-UserEmail | Text | | |
| TextMsg-MgrEmail | Text | TextMsg-AdminEmail | Text |
| 411-IsActive | Y/N | 411-Threshold | Numeric |
| 411-UserEmail | Text | 411-MgrEmail | Text |
| 411-AdminEmail | Text | | |
| 911-IsActive | Y/N | 911-UserEmail | Text |
| 911-MgrEmail | Text | 911-AdminEmail | Text |
| Toggle-IgnorePeakCellular | Y/N | Toggle-IgnoreOffPeak | Y/N |
| Toggle-IgnoreMobile2Mobile | Y/N | Toggle-IgnoreIncoming | Y/N |
| Toggle-IgnoreVoiceMail | Y/N | Toggle-IgnoreDispatch | Y/N |
| TriggerId | Numeric | SubscriberNbr | Numeric |
| | (PK) | | |
| PTN | Text | Unit Name | Text |
| BAN | Numeric | DACName | Text |
| DAC # | Text | UnitType | Text |
| Plan Description | Text | Bill Cycle | Date |
| Is Active | Y/N | | |
| Grouping Number | Numeric | Grouping Code | Text |

When designing the data tables for the database, a designer can ensure that the tables for storing trigger data are capable of listing screen to display and update the data and processing module to use it when processing the unbilled calls every day.

In some embodiments, the unbilled subscribers in the data report may not have UAD subscriber information. Data for these subscribers can be stored in a supplemental table, for example, the unbilled subscribers table to ensure that triggers can be established for any subscriber that is included in a data report.

In some embodiments, database integrity rules can be implemented. For example, in some embodiments there may be no duplicates or missing trigger records. As such, there can be exactly one trigger record for every distinct PTN found in the union of the UAD Subscriber and Unbilled Subscribers Tables. Every record in the Unbilled Subscriber Table should have a corresponding record in the UAD Subscriber Table with the same PTN. There can be more than one UAD Subscriber record for the same PTN, but there should only be exactly one Unbilled Subscribers record for each PTN. In some embodiments, the view that is the foundation for this listing screen can be based on the trigger table, joined to the Unbilled Subscribers Table (one-to-one join) and left outer join to UAD Subscribers (one-to-many). Where more than one UAD Subscriber record exists for any given PTN from trigger, a join only to the most recent UAD Subscribers Date Bill Cycle record can be performed.

### Triggers Fast Edit

In some embodiments, a fast edit feature can be provided in the trigger display. These fast edits can include one or more the following:
Update Multiple Items (up to 5 fields can be assigned at once for one or more records).
Update a Phrase in Multiple Items (a phrase within a particular field can be replaced for one or more records).
Delete Multiple Items—while not recommended, support to delete multiple riggers records can be provided. This delete has no effect on the UAD or Unbilled Subscriber data, but deletes the triggers record. In some embodiments, a blank trigger record for the PTN can be recreated with the next time a report for that subscriber's account is processed. This can be an effective way to disable many triggers at once.

Standard security checks can be done to verify that a user can access the Fast Edit features. Users that do not have update rights to the trigger entity can not be access fast edit options. Users without delete rights to the trigger entity can not access Fast Edit Delete Multiple Items. Changes to triggers data can be audited, in batch mode so that an audit record is created for each Fast Edit function and references the number of records modified and what Fast Edit function was applied.

Standard Security checks can be applied to the trigger entity. If a user has trigger UPDATE rights, then they can access this screen in edit mode. If a user has read only rights to trigger, then can access this screen in read only mode. In some embodiments, the read only mode can include a printer friendly mode. A user must have delete rights to view or edit a trigger delete checkbox. Standard auditing can be applied to the trigger entity. Audits can be recorded and visible from the History tab for all changes to a trigger's thresholds and properties.

### Trigger Processing Engine

The processing engine processes the unbilled calls for each subscriber, using the rules and options set up in the trigger listing. The processing engine can look at the most recent data for each subscriber and determine whether or not any of the existing thresholds have been exceeded. Once the triggers have been activated, the processing engine can send messages or emails if they have been configured for this particular subscriber. In some embodiments, the processing engine can ensure that the most recent data has not already been processed so as avoid generating duplicate processing or messages. In some embodiments the processing engine can be included in the trigger processing module.

### Usage Control

This trigger is activated when a subscriber is approaching their allotted number of cellular or dispatch air-time minutes. It can be implemented by, for example, usage control 144 of FIG. 1. It is calculated by summing the duration field of the Unbilled calls, taking into account the various “Distinction Toggles” explained below. Some carriers, for example, Sprint, round up for all call duration cellular minutes. Any cellular minutes that are over a whole minute, can be rounded up to the next whole minute. However, the carrier does not round up call numbers for dispatch minutes. For dispatch minutes, the exact call duration time is used to calculate thresholds.

This may be the most-commonly used trigger out of all of available triggers. This trigger can have options to send alerts when a subscriber is at 50%, 75%, 100%, and 150%, for example, of their airtime allotment. In some embodiments, a client's account manager can configure this trigger to submit a customized support tickets to a service provider whenever the subscriber exceeds 100% of their allotment. At least two types of usage triggers, cellular and dispatch. For each of these triggers, a field to set the threshold/allotment for the subscriber can be provided. Fields for this trigger can comprise:

| FieldName | Caption | Note |
|---|---|---|
| UsageTrigger-Cell-IsActive | Usage Cell IsActive | Checkbox - activates trigger |
| | | for processing |
| UsageTrigger-Cell-Threshold | Usage Cell Threshold | Numeric Text Box determines |
| | | the number of minutes that |
| | | this subscriber has been |
| | | allotted |
| UsageTrigger-Cell-50 | Usage Cell Send Email at 50% | Checkbox - indicates that an |
| | | email be sent when this |
| | | subscriber reaches 50% of |
| | | their allotment |
| UsageTrigger-Cell-75 | Usage Cell Send Email at 75% | Checkbox - indicates that an |
| | | email be sent when this |
| | | subscriber reaches 75% of |
| | | their allotment |
| UsageTrigger-Cell-100 | Usage Cell Send Email at | Checkbox - indicates that an |
| | 100% | email be sent when this |
| | | subscriber reaches 100% of |
| | | their allotment |
| UsageTrigger-Cell-150 | Usage Cell Send Email at | Checkbox - indicates that an |
| | Overtime | email be sent when this |
| | | subscriber reaches 150% of |
| | | their allotment |
| UsageTrigger-Cell-UserEmail | Usage Cell User Email | Textbox 100 chars, when |
| | | populated with non-null, valid |
| | | email, send email to this |
| | | address or semicolon |
| | | delimited list. |
| UsageTrigger-Cell-MgrEmail | Usage Cell Mgr Email | Textbox 100 chars, when |
| | | populated with non-null, valid |
| | | email, send email to this |
| | | address or semicolon |
| | | delimited list. |
| UsageTrigger-Cell- | Usage Cell Admin Email | Textbox 100 chars, when |
| AdminEmail | | populated with non-null, valid |
| | | email, send email to this |
| | | address or semicolon |
| | | delimited list. |
| UsageTrigger-Cell- | Usage Cell Restrict Usage | Checkbox, when checked it |
| RestrictUsage | after 100% | indicates that when the |
| | | subscriber exceeds 100% of |
| | | their allotted minutes, send a |
| | | restrict CELLULAR usage |
| | | email to National Orders, as |
| | | well as user, mgr and admin |
| | | emails if populated. |
| UsageTrigger-Disp-IsActive | Usage Dispatch IsActive | Checkbox - activates trigger |
| | | for processing |
| UsageTrigger-Disp-Threshold | Usage Dispatch Threshold | Numeric Text Box determines |
| | | the number of minutes that |
| | | this subscriber has been |
| | | allotted |
| UsageTrigger-Disp-50 | Usage Dispatch Send Email at | Checkbox - indicates that an |
| | 50% | email be sent when this |
| | | subscriber reaches 50% of |
| | | their allotment |
| UsageTrigger-Disp-75 | Usage Dispatch Send Email at | Checkbox - indicates that an |
| | 75% | email be sent when this |
| | | subscriber reaches 75% of |
| | | their allotment |
| UsageTrigger-Disp-100 | Usage Dispatch Send Email at | Checkbox - indicates that an |
| | 100% | email be sent when this |
| | | subscriber reaches 100% of |
| | | their allotment |
| UsageTrigger-Disp-150 | Usage Dispatch Send Email at | Checkbox - indicates that an |
| | 150% | email be sent when this |
| | | subscriber reaches 150% of |
| | | their allotment |
| UsageTrigger-Disp-UserEmail | Usage Dispatch User Email | Textbox 100 chars, when |
| | | populated with non-null, valid |
| | | email, send email to this |
| | | address or semicolon |
| | | delimited list. |
| UsageTrigger-Disp-MgrEmail | Usage Dispatch Mgr Email | Textbox 100 chars, when |
| | | populated with non-null, valid |
| | | email, send email to this |
| | | address or semicolon |
| | | delimited list. |
| UsageTrigger-Disp- | Usage Dispatch Admin Email | Textbox 100 chars, when |
| AdminEmail | | populated with non-null, valid |
| | | email, send email to this |
| | | address or semicolon |
| | | delimited list. |
| UsageTrigger-Disp- | Usage Dispatch Restrict | Checkbox, when checked it |
| RestrictUsage | Usage after 100% | indicates that when the |
| | | subscriber exceeds 100% of |
| | | their allotted minutes, send a |
| | | restrict DISPATCH usage |
| | | email to National Orders, as |
| | | well as user, mgr and admin |
| | | emails if populated. |

Various messages can be generated in response to an activation of this trigger. For example, messages to various client personnel, e.g., subscriber, manager, or administrator can contain the phone number/PTN of the wireless unit exceeding the threshold, the sum of the Total Amount column from unbilled call data for the subscriber, and duration of the calls for this subscriber. A Date Bill Cycle and User Name (the subscriber alias name) can be included in the email body. A flexible message system using tokens can provide customization of messages. For example, messages generated in response to this trigger can include a subject line that reads trigger Cellular Restriction Notification for device with PTN: {PTN}. A corresponding body of the email can read: “The trigger processing engine has found that a device with PTN: {PTN}, in Account: {AccountNbr/BAN} has exceeded its allotment of {UsageTrigger-CELL|Disp-Threshold} {“CELL”|“DISPATCH”} minutes. A modification has been submitted to National Orders for the restriction of this subscriber's Cellular|Dispatch usage for the remainder of this billing cycle.

An email can be sent to a service provider that can include an email subject can be formatted as: “trigger-Overtime Restriction Requested for PTN-{PTN}-Mod created ID: {DefectId}. The body can be formatted as: “The trigger processing engine has found that a device with PTN: {PTN}, in Account: {AccountNbr/BAN} has exceeded its allotment of {UsageTrigger-CELL|Disp-Threshold} {“CELL”|“DISPATCH”} minutes. The manager has requested that when this subscriber exceeds their allotted minutes that their usage be restricted. A Mode record with ID {DefectID} has been created.”

### Number Watch Control

This trigger allows the manager, user, administrator to receive alerts whenever a particular subscriber is making a certain number of calls to a particular number. It can be implemented by, for example, number watch control 146 of FIG. 1. There are different formulas that the user can select from for the calculation of this trigger. For example, a Total Number of Calls, with a threshold parameter supplied by provided by a trigger can be implemented. With this calculation method selected, the total number of calls to any of the listed numbers, e.g., home, spouse, other number 1, other number 2, and other number 3, is counted and compared that to the threshold number from the trigger. In some embodiments, a total length of calls trigger with a threshold in minutes supplied provided by a trigger can be implemented. With this calculation method, a sum of the duration of all calls made to any of the listed numbers is compared to the threshold minutes number supplied by the trigger threshold. In some embodiments, a trigger for percentage to total duration, with a threshold percentage provided by a trigger can be implemented. With this calculation method, a sum of the duration of all calls made to any of the listed numbers is divided by the sum of all unbilled calls. The result of this calculation is then multiplied by 100 and compared to the threshold parameter supplied by the trigger. The following fields can be used for this trigger. In some embodiments, a single “Formula” field to store the formula and parameter is provided for storing the selected formula and threshold value.

| FieldName | Caption | Note |
|---|---|---|
| NbrWatch-IsActive | Number Watch IsActive | Checkbox to indicate whether |
| | | or not this trigger is active. |
| NbrWatch-Calc-Formula | TBD | Storage of calculation |
| | | parameter, and formula |
| NbrWatch-SpouseNbr | Number Watch Spouse | Text box, 20 char, one of 5 |
| | Number | numbers that can be observed |
| NbrWatch-HomeNbr | Number Watch Home Number | Text box, 20 char, one of 5 |
| | | numbers that can be observed |
| NbrWatch-OtherNbr1 | Number Watch Other Number 1 | Text box, 20 char, one of 5 |
| | | numbers that can be observed |
| NbrWatch-OtherNbr2 | Number Watch Other Number 2 | Text box, 20 char, one of 5 |
| | | numbers that can be observed |
| NbrWatch-OtherNbr3 | Number Watch Other Number 3 | Text box, 20 char, one of 5 |
| | | numbers that can be observed |
| NbrWatch-UserEmail | Number Watch User Email | Textbox 100 chars, when |
| | | populated with non-null, valid |
| | | email, send email to this |
| | | address or semicolon |
| | | delimited list. |
| NbrWatch-MgrEmail | Number Watch Manager Email | Textbox 100 chars, when |
| | | populated with non-null, valid |
| | | email, send email to this |
| | | address or semicolon |
| | | delimited list. |
| NbrWatch-AdminEmail | Number Watch Admin Email | Textbox 100 chars, when |
| | | populated with non-null, valid |
| | | email, send email to this |
| | | address or semicolon |
| | | delimited list. |

The email that is sent when this trigger is fired can include a subject of the email that can read “Trigger Number Watch Threshold Exceeded for device with PTN: {PTN}.” The body of the email can be “The trigger processing engine has found that a device with PTN: {PTN}, in Account: {AccountNbr/BAN} has exceeded the Number to Watch threshold.”

When the trigger is for the total number of calls the following text can be added. “This trigger is configured to send alerts whenever this device has called the watched numbers more than {ThresholdVal} times. This device has made calls to watched numbers {NbrCallsMadeToWatchedNbrs} times.”

When the trigger is for duration of calls a trigger the following text can be added. “This trigger is configured to send alerts whenever this device has exceeded {ThresholdVal} minutes of air time for watched numbers. This device has made calls lasting a total of {DurationCallsMadeToWatchedNbrs} minutes.”

When the trigger is for percentage to Total the following text can be added. “This trigger is configured to send alerts whenever the total percentage of calls to watched numbers exceeds {ThresholdVal}% of the duration of ALL calls made. {DurationPctWatchedNbrs}% of calls made from this device are to watched numbers at this time.”

In some embodiments, a listing of all calls made to the observed numbers can be added. The text can comprise the following format: xxx-xxx-xxxx (Spouse)-{DateTimeOfCall} ({Duration} min). In some embodiments, this message can be sent to the subscriber, Manager and Admin email addresses, if supplied.

### Time of Day Control

The time of day usage trigger is designed to notify users, managers, and administrators whenever devices are being used during specific times of day. It can be implemented by, for example, time of day control 148 of FIG. 1. The following fields can be used for this trigger:

| FieldName | Caption | Note |
|---|---|---|
| TimeOfDay-IsActive | Time of Day | Checkbox to indicate whether |
| | IsActive | or not this trigger is active |
| TimeOfDay-UserEmail | Time Of Day | Textbox 100 chars, when |
| | User Email | populated with non-null, valid |
| | | email, send email to this |
| | | address or semicolon |
| | | delimited list. |
| TimeOfDay-MgrEmail | Time of Day | Textbox 100 chars, when |
| | Mgr Email | populated with non-null, valid |
| | | email, send email to this |
| | | address or semicolon |
| | | delimited list. |
| TimeOfDay-AdminEmail | Time of Day | Textbox 100 chars, when |
| | Admin Email | populated with non-null, valid |
| | | email, send email to this |
| | | address or semicolon |
| | | delimited list. |
| TimeOfDay-UsageTypes | Usage Type | Choice List with values: All, |
| | | Cellular, Dispatch, Incoming |
| | | Only, Outgoing Only |
| TimeOfDay-Start1 | Time Start 1 | Textbox with time for start of |
| | | monitoring period 1 |
| TimeOfDay-End1 | Time End 1 | Text box with time for end of |
| | | monitoring period 1 |
| TimeOfDay-Start2 | Time Start 2 | Textbox with time for start of |
| | | monitoring period 1 |
| TimeOfDay-End2 | Time End 2 | Text box with time for end of |
| | | monitoring period 1 |

A message can be sent in response to an activation of this trigger. The subject of the message can read “trigger Time of Day Usage Notification for device with PTN: {PTN}.” The body of the email can be “The trigger processing engine has found that a device with PTN: {PTN}, in Account: {AccountNbr/BAN} has been used during a monitored block of time. This trigger is configured to send alerts whenever the device is used between {StartTime1} and {EndTime1} (IF EXISTS BLOCK2+“or {StartTime2} and {EndTime2}.” Moreover, a listing of all calls made during a watched time periods can be include in the message. Below the list of calls, a total for duration of calls made during the watched time periods can be provided.

### Text Messaging Control

This trigger can send a message whenever the number of texts exceeds or meets a threshold. The threshold can be supplied by a user, manager or administrator. For example, alerts for 90%, 150%, 200%, etc., can be set as the threshold value. It can be implemented by, for example, text messaging control 150 of FIG. 1. Fields for this trigger can include:

| FieldName | Caption | Note |
|---|---|---|
| TextMsg-IsActive | Text Messaging IsActive | Checkbox to determine |
| | | whether or not this trigger is |
| | | active |
| TextMsg-Threshold | Text Messaging Threshold | Number of Text Messages |
| | | allowed |
| TextMsg-50 | Text Messaging Email at 50% | Checkbox - indicates that an |
| | of threshold | email be sent when this |
| | | subscriber reaches 50% of |
| | | their allotment |
| TextMsg-75 | Text Messaging Email at 75% | Checkbox - indicates that an |
| | of threshold | email be sent when this |
| | | subscriber reaches 75% of |
| | | their allotment |
| TextMsg-100 | Text Messaging Email at | Checkbox - indicates that an |
| | 100% of threshold | email be sent when this |
| | | subscriber reaches 100% of their |
| | | allotment |
| TextMsg-150 | Text Messaging Email at | Checkbox - indicates that an |
| | 150% of threshold | email be sent when this |
| | | subscriber reaches 150% of |
| | | their allotment |
| TextMsg-UserEmail | Text Messaging User Email | Textbox 100 chars, when |
| | | populated with non-null, valid |
| | | email, send email to this |
| | | address or semicolon |
| | | delimited list. |
| TextMsg-MgrEmail | Text Messaging User Email | Textbox 100 chars, when |
| | | populated with non-null, valid |
| | | email, send email to this |
| | | address or semicolon |
| | | delimited list. |
| TextMsg-AdminEmail | Text Messaging User Email | Textbox 100 chars, when |
| | | populated with non-null, valid |
| | | email, send email to this |
| | | address or semicolon |
| | | delimited list. |

The subject of the email can be “Trigger Text Messaging Threshold Exceeded for device with PTN: {PTN}.” The body of the email can be “The trigger processing engine has found that a device with PTN: {PTN}, in Account: {AccountNbr/BAN} has reached {90|100|200}% of the {ThresholdVal} Text Messages threshold.

### 411 Control

This trigger can send an email to the user, manager, or administrator whenever a particular subscriber calls 411 more than a specific number of times. It can be implemented by, for example, 411 control 152 of FIG. 1. Fields for this trigger can include:

| FieldName | Caption | Note |
|---|---|---|
| 411-IsActive | 411 IsActive | Checkbox to determine |
| | | whether or not this trigger is |
| | | active |
| 411-Threshold | 411 Calls Threshold | Numeric text box, represents |
| | | the number of times that a |
| | | user is allowed to call 411 in a |
| | | given billing period |
| 411-UserEmail | 411 User Email | Textbox 100 chars, when |
| | | populated with non-null, valid |
| | | email, send email to this |
| | | address or semicolon |
| | | delimited list. |
| 411-MgrEmail | 411 Manager Email | Textbox 100 chars, when |
| | | populated with non-null, valid |
| | | email, send email to this |
| | | address or semicolon |
| | | delimited list. |
| 411-AdminEmail | 411 Admin Email | Textbox 100 chars, when |
| | | populated with non-null, valid |
| | | email, send email to this |
| | | address or semicolon |
| | | delimited list. |

The subject of the email can be “trigger 411 Control Threshold Exceeded for device with PTN: {PTN}.” The body of the email can be “The trigger processing engine has found that a device with PTN: {PTN}, in Account: {AccountNbr/BAN} has exceeded the 411 call threshold of {ThresholdVal}. 411 has been called by this device {NbrTimes411Called} for this device.”

### 911 Control

This trigger can send an email whenever 911 is called. It can be implemented by, for example, 911 control 154 of FIG. 1. Fields for this trigger can include:

| FieldName | Caption | Note |
|---|---|---|
| 911-IsActive | 911 IsActive | Checkbox to determine |
| | | whether or not this trigger is |
| | | active |
| 911-UserEmail | 911 User Email | Textbox 100 chars, when |
| | | populated with non-null, valid |
| | | email, send email to this |
| | | address or semicolon delimited |
| | | list. |
| 911-MgrEmail | 911 Manager Email | Textbox 100 chars, when |
| | | populated with non-null, valid |
| | | email, send email to this |
| | | address or semicolon delimited |
| | | list. |
| 911-AdminEmail | 911 Admin Email | Textbox 100 chars, when |
| | | populated with non-null, valid |
| | | email, send email to this |
| | | address or semicolon delimited |
| | | list. |

The subject of the email can be “trigger 911 called from device with PTN: {PTN}.” The body of the email can be “The trigger processing engine has found that a device with PTN: {PTN}, in Account: {AccountNbr/BAN} has called 911. A listing of the 911 calls made including their date time and duration can be provided.

### Reporting and Dashboards

Reports and screens for a service provider's internal use can be provided for management purposes, e.g. report display 134 of FIG. 1. An example report for a service provider, for example, can summarize trigger that have been sent by month.

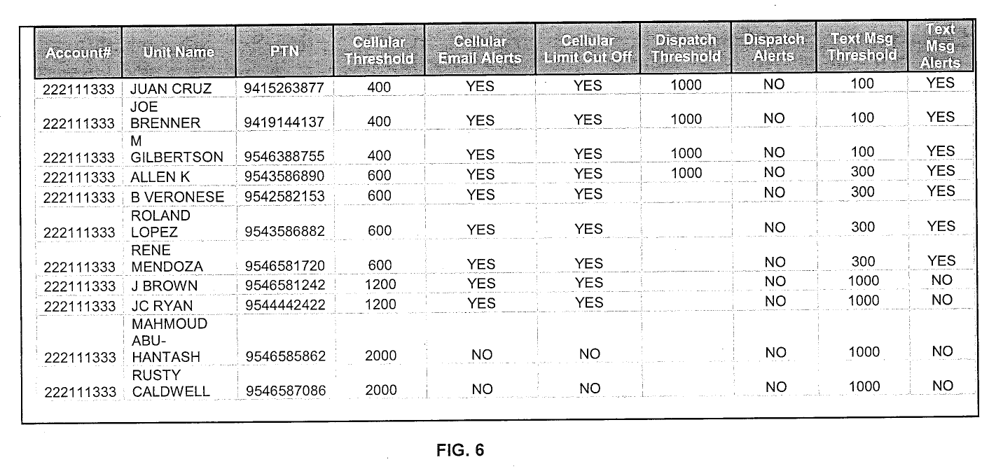

FIG. 6 illustrates some exemplary values for threshold and trigger setup. The thresholds and triggers illustrated can be setup for a typical industry billing cycle of one month or 30 days. The billings can be processing according to the teachings herein daily. In some embodiments, the billings can be processed twice a day or more frequently. As more fraud prevention or finer control of trigger thresholds being exceeded is desired, the interval between processing the account data can be shortened. In some embodiments, the triggers are examined as usage data is inserted in the logical database or real-time.

The various embodiments described above are provided by way of illustration only and should not be constructed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

What is claimed is:

1. A method for monitoring wireless service utilization comprising:
providing a logical database comprising service usage records;
providing triggers for a wireless service consumed by a wireless device;
providing a contact address associated with the wireless device;
after an interval, determining if the utilization consumed to-date for a current billing period by the wireless device activates one of the triggers, wherein the interval is at least an order of magnitude less than a billing period;
generating a message corresponding to the activated trigger, with the message including values determined during the determining step; and
sending the message to the contact address.

2. The method of claim 1, further comprising:
summarizing the usage records for the interval prior to the determining; and
storing the summarized usage records.

3. The method of claim 1, wherein the determining comprises adding the usage records created within the interval to a summary usage record summarizing a period between the start of the billing period and the interval start.

4. The method of claim 1, wherein the logical database groups usage records by an account number with the account number grouping subscribers.

5. The method of claim 1, wherein the logical database comprises one or more databases that are commonly keyed and owned by different entities.

6. The method of claim 1, wherein the interval is 24 hours.

7. The method of claim 1, wherein the contact address comprises one or more of a telephone number, an email address, or an instant message user identifier.

8. The method of claim 1, wherein the contact address contacts one of more of a subscriber, a subscriber supervisor, a service provider account manager, or a wireless carrier billing manager.

9. The method of claim 1, wherein the logical database comprises importing a file including usage records from a wireless carrier database.

10. The method of claim 9, wherein the importing comprises receiving an email including the file at a desired email address, and inserting the usage records included in the file into the logical database.

11. The method of claim 9, wherein the importing comprises sending a notification email to a service provider.

12. The method of claim 1, wherein the wireless service comprises one or more of voice minutes, text messages, multi-media messages or bytes of data.

13. The method of claim 1, wherein the wireless service comprises expenses incurred for international calls.

14. The method of claim 1, further comprising disabling a use of a service that activated the trigger till the end of the billing period.

15. The method of claim 1, wherein the trigger comprises one or more of usage control, number watch control, time of day control, text messaging control, 411 Control, and 911 Control.

16. A system for monitoring wireless service utilization comprising:
a logical database comprising service usage records;
triggers for a wireless service consumed by a wireless device;
a contact address associated with the wireless device;
a trigger processing module that runs after an interval to determine if the utilization consumed to-date for a current billing period by the wireless device activates one of the triggers, wherein the interval is at least an order of magnitude less than a billing period;
a message generator to generate a message corresponding to the activated trigger, with the message including values determined by the trigger processing module; and
a message sender to send the message to the contact address.

17. The system of claim 16, further comprising:
a summarizer to collate the usage records for the interval; and
a storage to store the summarized usage records.

18. The system of claim 16, wherein the determining comprises adding the usage records created within the interval to a summary usage record summarizing a period between the start of the billing period and the interval start.

19. The system of claim 16, wherein the logical database groups usage records by an account number with the account number grouping subscribers.

20. The system of claim 16, wherein the logical database comprises one or more databases that are commonly keyed and owned by different entities.

21. The system of claim 16, wherein the contact address comprises one or more of a telephone number, an email address, or an instant message user identifier.

22. The system of claim 16, further comprising a data collection module to import a file including usage records from a wireless carrier.

23. The system of claim 22, wherein the data collection module comprises an email agent to receive the file at a desired email address and a data import to import the usage records included in the file.

24. The system of claim 16, further comprising a notification email agent to transmit a message to a service provider.

25. The system of claim 16, wherein the trigger processing module comprises controls for one or more of multi-media messages or bytes of data.

26. The system of claim 16, wherein the trigger processing module comprises controls for expenses incurred for international calls.

27. The system of claim 16, further comprising a service ticket module to disable a use of a service that activated the trigger till the end of the billing period.

28. The system of claim 16, wherein the trigger processing module comprises controls for one or more of usage control, number watch control, time of day control, text messaging control, 411 Control, and 911 Control.

29. A computer readable medium in which software is recorded, wherein the software is configured to implement a method for monitoring wireless service utilization comprising:
providing a logical database comprising service usage records;
providing triggers for a wireless service consumed by a wireless device;
providing a contact address associated with the wireless device;
after an interval, determining if the utilization consumed to-date for a current billing period by the wireless device activates one of the triggers, wherein the interval is at least an order of magnitude less than a billing period;
generating a message corresponding to the activated trigger, with the message including values determined during the determining step; and
sending the message to the contact address.
